(19) United States
(12) Patent Application Publication
(10) Pub. No.: US 2002/0095299 A1
(43) Pub. Date: Jul. 18, 2002

(54) CUSTOMER INFORMATION CONTROL SYSTEM AND CUSTOMER INFORMATION CONTROL METHOD OF ELECTRONIC EQUIPMENT

(76) Inventor: NOBUYUKI IWAKATA, TOKYO (JP)

Correspondence Address: YOUNG & THOMPSON, 745 SOUTH 23RD STREET 2ND FLOOR, ARLINGTON, VA, 22202

(21) Appl. No.: 09/419,803

(22) Filed: Oct. 18, 1999

(30) Foreign Application Priority Data
Oct. 19, 1998 (JP) 10-315444

(51) Int. Cl. G06F 17/60

(52) U.S. Cl. 705/1

(57) ABSTRACT

A customer information control system of electronic equipment for controlling personal information and product identification information of the electronic equipment belonging to a customer, as customer management information, on a host machine, in which the electronic equipment automatically reads out the product identification information from a product identification information storing unit for storing the product identification information in a readable way and sends the product identification information and the personal information to the host machine as the customer management information, while the host machine receives the customer management information from the electronic equipment and when the customer management information has not been registered in a customer information database, registers the sent customer management information into the customer information database.

### BACKGROUNDS OF THE INVENTION

1 Field of the Invention

The present invention relates to a customer information control system for obtaining customer information of electronic equipment including a personal computer (hereinafter, referred to as a PC) and controlling the same, and more particularly, it relates to a customer information control system and customer information control method for preventing input errors or false value entry of product identification information, such as manufacturer's serial number, attached to every product of the electronic equipment.

2 Description of the Related Art

When having bought electronic equipment such as a PC, generally a customer reads out the product identification information including model number and manufacturer's serial number printed on the electronic equipment and fills the same information in a customer registration card together with the personal information including his or her name and address, thereby to inform a maker of his or her registration. Such a customer registration is notified by entering the above product identification information such as the model number and manufacturer's serial number and the above personal information via E-mail using the Internet or the like, other than the above customer registration card.

Upon receipt of the customer registration notification from a customer, a maker enters the above product identification information and personal information into a database for registering customers according to the content of the customer registration card or E-mail, so to manage the customers based on the database.

In the above conventional customer information control, a customer writes the product identification information of electronic equipment such as model number and manufacturer's serial number and the personal information by hand or enters the same information via E-mail, and an operator enters the same information into a database for customer registration, thereby completing a customer information registration. In this way, there is a possibility that a registration mistake or double registration of a customer may occur owing to some input error on the customer side and/or the operator side.

There is also a problem that a maker cannot cope with such a false registration that some product identification information is maliciously changed.

Further, it is very troublesome for a customer to read out the product identification information attached to the product itself and fill the same in a customer registration form and it is also very troublesome for a maker to enter the registration information into a database for customer registration. Especially a customer unskilled in the electronic equipment is troubled by only recognizing the product identification information.

### SUMMARY OF THE INVENTION

A first object of the present invention is to provide a customer information control system and customer information control method for preventing someone's input errors and false value entry by handwork, by automatically obtaining the product identification information such as the manufacturer's serial number of electronic equipment itself, which is necessary for controlling customer information of the electronic equipment such as a personal computer.

A second object of the present invention is to provide a customer information control system and customer information control method capable of saving a lot of customer's trouble toward customer registration and a lot of operator's trouble of information input.

A third object of the present invention is to provide a customer information control system and customer information control method capable of simplifying a customer information control as well as saving a customer's trouble toward customer registration and operator's trouble of issuing the user registration number.

According to the first aspect of the invention, a customer information control system of electronic equipment for controlling personal information and product identification information of the electronic equipment belonging to a customer, as customer management information, on a host machine, wherein

the electronic equipment comprises

a product identification information storing unit for storing the product identification information in a readable way,

an information reading unit for automatically reading out the product identification information from the product identification information storing unit,

an input unit for entering the personal information, and

a data sending unit for sending the product identification information and the personal information to the host machine as the customer management information,

the host machine comprises

a receiving unit for receiving the customer management information from the electronic equipment,

a customer information database for storing the customer management information, and

a registering unit for registering the sent customer management information into the customer information database when the customer management information sent from the electronic equipment has not been registered in the customer information database.

In the preferred construction, the electronic equipment further comprises a display unit for displaying the personal information and a request and result from the host machine, and a data receiving unit for receiving the request and result from the host machine,

the host machine comprises a checking unit for comparing the customer management information sent from the electronic equipment with the customer management information within the customer information database.

In another preferred construction, the host machine further comprises a control unit for requiring the electronic equipment to enter the personal information after confirming the connection to the electronic equipment and controlling the information reading unit to read out the product identification information from the product identification information storing unit after confirming entry of the personal information.

In another preferred construction, the host machine comprises a control unit for, after confirming the connection to the electronic equipment, asking the electronic equipment whether the customer management information is to be registered newly or to be updated, when the same information is to be registered newly, controlling the information reading unit to read out the product identification information from the product identification information storing unit, after confirming the entry of the personal information from the electronic equipment, when the same information is to be updated, controlling the checking unit to compare the personal information entered from the electronic equipment and the product identification information read out by the information reading unit with the customer management information within the customer information database, and when there is a match, controlling the registering unit to update the customer management information within the customer information database according to the personal information changed by the electronic equipment.

In another preferred construction, when the customer management information sent from the electronic equipment has not been registered, the checking unit of the host machine notifies the effect to the registering unit, so to register the sent customer management information into the customer information database, while when the sent customer management information has been already registered, the checking unit notifies the error to the input unit and displaying unit of the electronic equipment and makes a change request.

In another preferred construction, the electronic equipment comprises a control unit for requiring the electronic equipment to enter the personal information after confirming the connection to the electronic equipment and controlling the information reading unit to read out the product identification information from the product identification information storing unit after confirming the entry of the personal information.

In another preferred construction, the electronic equipment comprises a control unit for, after confirming the connection to the host machine, asking the host machine whether the customer management information is to be registered newly or to be updated, when the same information is to be registered newly, controlling the information reading unit to read out the product identification information from the product identification information storing unit, after confirming the entry of the personal information, while when the same information is to be updated, controlling the checking unit to compare the entered personal information and the product identification information read out by the information reading unit with the customer management information within the customer information database, and when there is a match, controlling the registering unit to update the customer management information within the customer information database according to the changed personal information.

In another preferred construction, the host machine comprises a registration number issuing unit for issuing a user registration number of uniquely identifying a customer indicated in the registered product identification information and personal information,

the registering unit registering the issued user registration number into the customer information database, and sending the same registration number to the electronic equipment.

In another preferred construction, the electronic equipment belonging to a customer consists of a computer and peripheral equipment connected to the computer,

the computer and peripheral equipment respectively comprising the product identification information storing unit for storing the product identification information for uniquely identifying the computer and peripheral equipment,

the host machine comprises the plurality of customer information databases for every computer and peripheral equipment.

In another preferred construction, the electronic equipment comprises an automatic connecting unit for automatically connecting with the host machine upon recognizing the fist activation.

According to the second aspect of the invention, a customer information control method of electronic equipment for controlling personal information and product identification information of the electronic equipment belonging to a customer, as customer management information, on a host machine, comprising the following steps of:

automatically reading out the product identification information from the product identification information storing unit for storing the product identification information of the electronic equipment in a readable way,

sending the product identification information and the personal information entered from the electronic equipment to the host machine as the customer management information,

comparing the customer management information sent from the electronic equipment with the customer management information registered in the customer information database of the host machine, and

registering the sent customer management information into the customer information database when the sent customer management information has not been registered in the customer information database as the result of the comparison.

In the preferred construction, the customer information control method of electronic equipment further comprises a step of requiring the electronic equipment to enter the personal information after confirming the connection to the electronic equipment and reading out the product identification information from the product identification information storing unit after confirming the entry of the personal information.

In another preferred construction, the customer information control method of electronic equipment comprising the following steps of:

after confirming the connection to the electronic equipment, asking the electronic equipment whether the customer management information is to be registered newly or to be updated,

when the same information is to be registered newly, reading out the product identification information from the product identification information storing unit, after confirming the entry of the personal information from the electronic equipment, and

when the same information is to be updated, comparing the personal information entered from the electronic equipment and the product identification information read out from the customer information database with the customer management information within the customer information database, and when there is a match, updating the customer management information within the customer information database according to the personal information changed on the side of the electronic equipment.

In another preferred construction, the customer information control method of electronic equipment comprises a step of, when the customer management information sent from the electronic equipment has not been registered, registering the sent customer management information into the customer information database, and when the sent customer management information has been already registered, notifying the error and making a change request to the electronic equipment.

In another preferred construction, the customer information control method of electronic equipment comprising the following steps of:

issuing a user registration number of uniquely identifying a customer indicated in the registered product identification information and personal information, from the host machine, and

registering the issued user registration number into the customer information database as well as sending the same registration number to the electronic equipment.

In another preferred construction, the electronic equipment consists of a computer and peripheral equipment connected to the computer, the computer and peripheral equipment respectively comprising the product identification information storing unit for storing the product identification information for uniquely identifying the computer and peripheral equipment.

According to another aspect of the invention, a computer readable memory for storing a customer information control program for controlling personal information and product identification information of electronic equipment belonging to a customer, as customer management information, on a host machine, wherein

the customer information control program automatically reads out the product identification information from the product identification information storing unit for storing the product identification information of the electronic equipment in a readable way,

sends the product identification information and the personal information entered from the electronic equipment to the host machine as the customer management information,

compares the customer management information sent from the electronic equipment with the customer management information registered in the customer information database of the host machine, and

registers the sent customer management information into the customer information database when the sent customer management information has not been registered in the customer information database as the result of the comparison.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing the structure of a customer information control system according to a first embodiment of the present invention;

FIG. 2 is a view showing an example of a customer information database according to the first embodiment;

FIG. 3 is a flow chart for use in describing the operation of the customer information control system according to the first embodiment;

FIG. 4 is a flow chart for use in describing the process of newly registering customer management information in the customer information control system according to the first embodiment;

FIG. 5 is a flow chart for use in describing the update process of the customer management information in the customer information control system according to the first embodiment;

FIG. 6 is a flow chart for use in describing the update process of the customer management information in the customer information control system according to the first embodiment;

FIG. 7 is a block diagram showing the structure of a customer information control system according to a second embodiment of the present invention;

FIG. 8 is a view showing an example of a customer information database according to the second embodiment;

FIG. 9 is a flow chart for use in describing the operation of a customer information control system according to the second embodiment;

FIG. 10 is a flow chart for use in describing the operation of the customer information control system according to the second embodiment.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

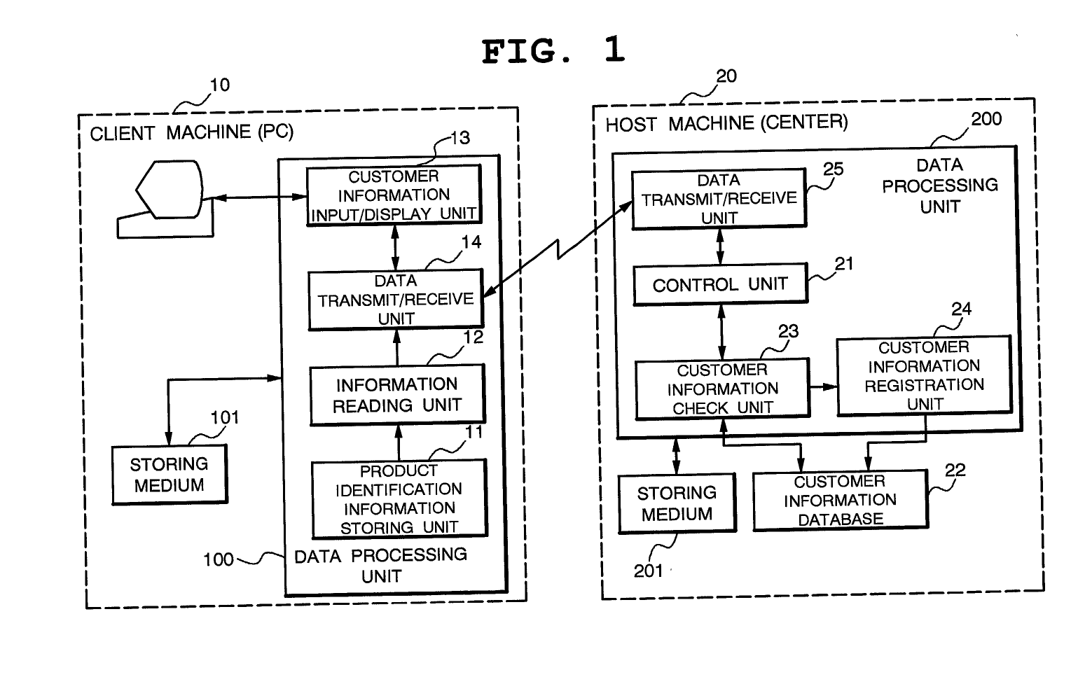

FIG. 1 is a block diagram showing the whole structure of a customer information control system according to a first embodiment of the present invention. In this embodiment, the description will be made in the case where a customer bought a PC, by way of example, as electronic equipment.

In FIG. 1, the customer information control system consists of a PC (client machine) 10 belonging to a customer and a host machine (center) 20 of a maker who registers customer information. FIG. 1 shows only the components necessary for customer information control, and the description of the other components for realizing the other functions provided in the client machine 10 and the host machine 20 is omitted there for convenience's sake.

The client machine 10 comprises a product identification information storing unit 11 realized by a ROM or the like having the product identification information PII previously stored therein, an information reading unit 12 for reading out the product identification information PII from the product identification information storing unit 11, a customer information input/display unit 13 for receiving and confirming customer information and displaying check results of the stored information and the received information, and a data transmit/receive unit 14 for sending customer management information to the host machine 20 and receiving the predetermined information from the host machine 20. The above customer information input/display unit 13 may be divided into an input unit and a display unit.

A data processing unit (CPU) 101 of the client machine 10 performs each function of the information reading unit 12, the customer information input/display unit 13, and the data transmit/receive unit 14.

The product identification information PII stored in the product identification information storing unit 11 is the control information for identifying the individual products. For example, the product identification information PII includes the product model number, manufacturer's serial number, and the like which are provided in advance (at the shipment) in order to identify each client machine 10. The information reading unit 12 reads out the product identification information PII stored in the product identification information storing unit 11, and the unit 12 is provided with an interface function of enabling the same information to be utilized in the following process.

The customer information input/display unit 13 receives the personal information PI necessary for a customer information control by the host machine 20 and displays the results of data check from the host machine 20 (including double registration error as for the same PC). The personal information includes, for example, “name”, “address”, “password”, and the like.

The data transmit/receive unit 14 sends the personal information PI entered by a customer and the product identification information PII automatically read out by the information reading unit 12 to the host machine 20 as a set of customer management information CI. The unit 14 also displays errors and the customer management information CI stored in the host machine 20.

The host machine 20 comprises a control unit 21, a customer information database 22, a customer information check unit 23, a customer information registration unit 24, and a data transmit/receive unit 25. A data processing unit 200 of the host machine 20 performs each function of the control unit 21, the customer information check unit 23, the customer information registration unit 24, and the data transmit/receive unit 25.

The control unit 21 analyzes the customer management information CI received from the client machine 10 and sends the existing information and error information from the host machine 20 to the client machine 10. Further, the unit 21 is provided with a control function of data transfer between the client machine and the host machine.

In this case, the host machine takes the initiative in transferring data between the client machine and the host machine according to the control by the control unit 21. Depending on the form of a system, however, this control function may be provided on the side of the client machine.

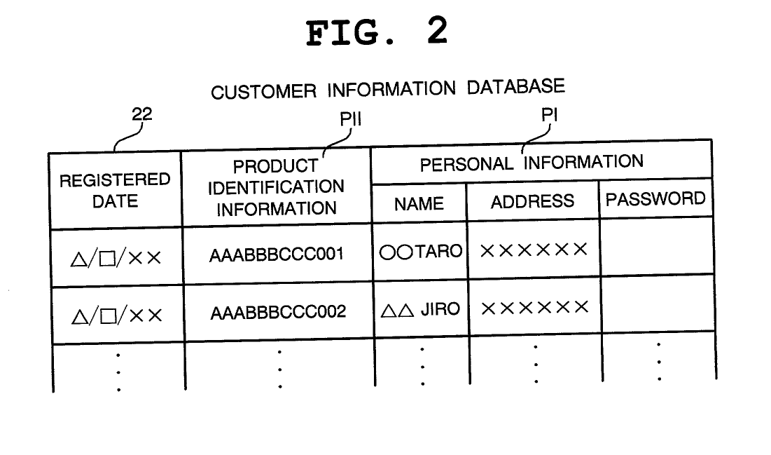

The customer information database 22 is the database for storing the product identification information PII and the personal information PI included in the customer management information CI sent from the client machine 10 for the purpose of the customer management. An example of the customer information database 22 is shown in FIG. 2.

The customer information check unit 23 checks whether a client machine has been registered or not, by comparing the personal information PI and the product identification information PII obtained from the client machine 10 with the existing information stored in the customer information database 22. When there is overlap therebetween, the effect is notified to the client machine 10.

The customer information registration unit 24 stores the obtained personal information PI and product identification information PII into the customer information database 22 when the client machine has been judged to be an unregistered machine as the result of the comparison. The data transmit/receive unit 25 receives the customer management information CI sent from the client machine 10 and sends the customer management information CI stored on the side of the host machine 20 and error notification to the client machine 10.

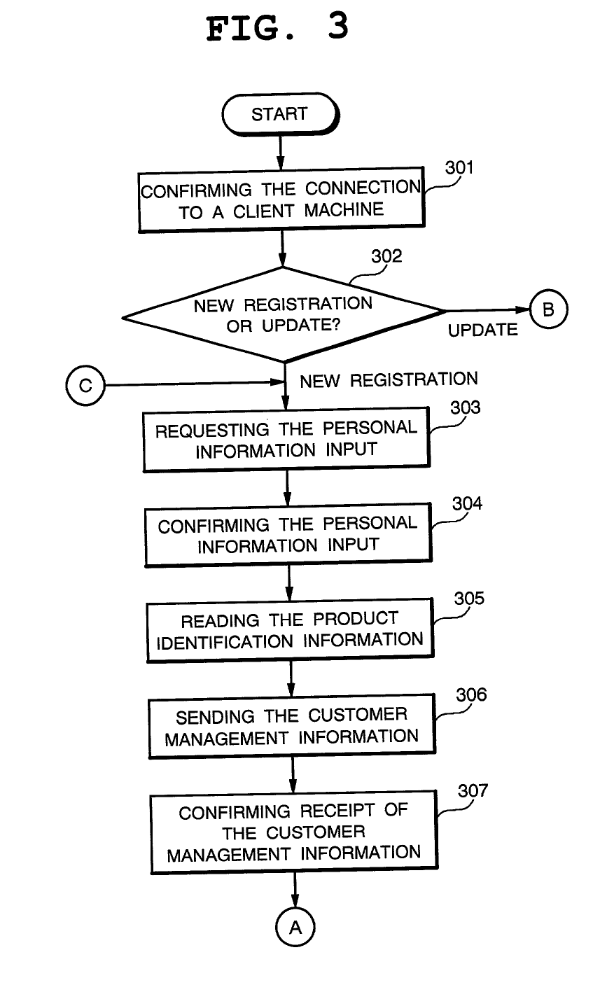

This time, the operation of the customer information control system having the above-mentioned structure will be described with reference to the flow charts of FIGS. 3 to 6.

The client machine 10 and the host machine 20 are individually activated and connected with each other via a communication line 300 or the like. At the confirmation of the connection (Step 301), a control from the host machine 20 to the client machine 10 is started. Alternatively, the client machine 10 may take the initiative as mentioned above.

The host machine 20 asks whether it is new registration of the customer management information or update of the personal information (Step 302).

In the case of new registration of the customer management information, the customer information input/display unit 13 is activated at first in the client machine 10, to require the customer to enter the personal information PI (Step 303). The customer enters the personal information PI including name, address, password, and the like according to the request for entering the personal information.

At the time of confirming the personal information input (Step 304), the product identification information previously stored in the information storing unit 11 is automatically read out by the information reading unit 12, in the client machine 10 (Step 305).

The entered personal information is combined with the read out product identification information as a set of customer management information CMI, which is sent to the host machine 20 via the data transmit/receive unit 14 (Step 306).

The host machine 20 analyzes the customer management information CMI from the client machine 10 and confirms the receipt of it (Step 307).

The customer information check unit 23 compares the personal information PI and the product identification information PII included in the received customer management information CMI with the existing information stored in the customer information database 22 (Step 308), and judges whether the same client machine has been registered or not (Step 309). When the received personal information PI and product identification information PII is of unregistered machine, the effect is notified to the customer information registration unit 24 (Step 310).

Upon receipt of the notification, the customer information registration unit 24 stores the personal information and the product identification information included in the customer management information into the customer information database 22 as the new information (Step 311).

As the result of the comparison, when the product identification information has been already registered, the error information is notified to the client machine 10 as a double registration as for the existing machine (Step 312). The client machine 10 informs the error information from the host machine 20 of the customer and requires the customer to change the personal information PI (Step 303).

When changing the personal information PI in Step 302, the control unit 21 of the host machine 20 requires the information reading unit 12 of the client machine 10 to read out the product identification information previously stored in the information storing unit 11 (Step 401) and requires the customer to enter the password, activating the customer information input/display unit 13 (Step 402).

Receiving the product identification information and the password (Step 403), the control unit 21 of the host machine 20 retrieves the customer information database 22 according to the received product identification information and password and checks whether there exists the customer management information CMI matched with the same information and password (Step 404). When there exists no matched customer management information CMI, it requires the customer to enter the password again.

When there exists the matched customer management information CMI, the unit 21 reads out the corresponding product identification information PII and the personal information PI from the customer information database 22 (Step 405), sends the read-out product identification information and personal information to the client machine 10 (Step 406), and activates the customer information input/display unit 13 so to require the customer to modify the personal information (Step 407).

Upon confirming the modification of the personal information PI (Step 608), the modified personal information PI is sent to the host machine 20 (Step 409).

In the host machine 20, after confirming the receipt of the modified personal information PI (Step 410), the customer information check unit 23 compares the modified personal information PI having been received with the corresponding personal information within the customer information database 22 (Step 411), so to check whether there is a change in the personal information PI (Step 412).

When there is a change, it is notified to the customer information registration unit 24 (Step 413), and the corresponding personal information PI within the customer information database 22 is updated (Step 414). When there is no change in the personal information PI, the process will be finished.

In the above-mentioned first embodiment, the product identification information PII is automatically obtained according to the above-mentioned operation, thereby preventing a registration mistake and double registration owing to a user's mistake and preventing such a false registration that the product identification information is maliciously changed. Further, the embodiment can save a lot of customer's labor toward customer registration and a lot of operator's labor of information input.

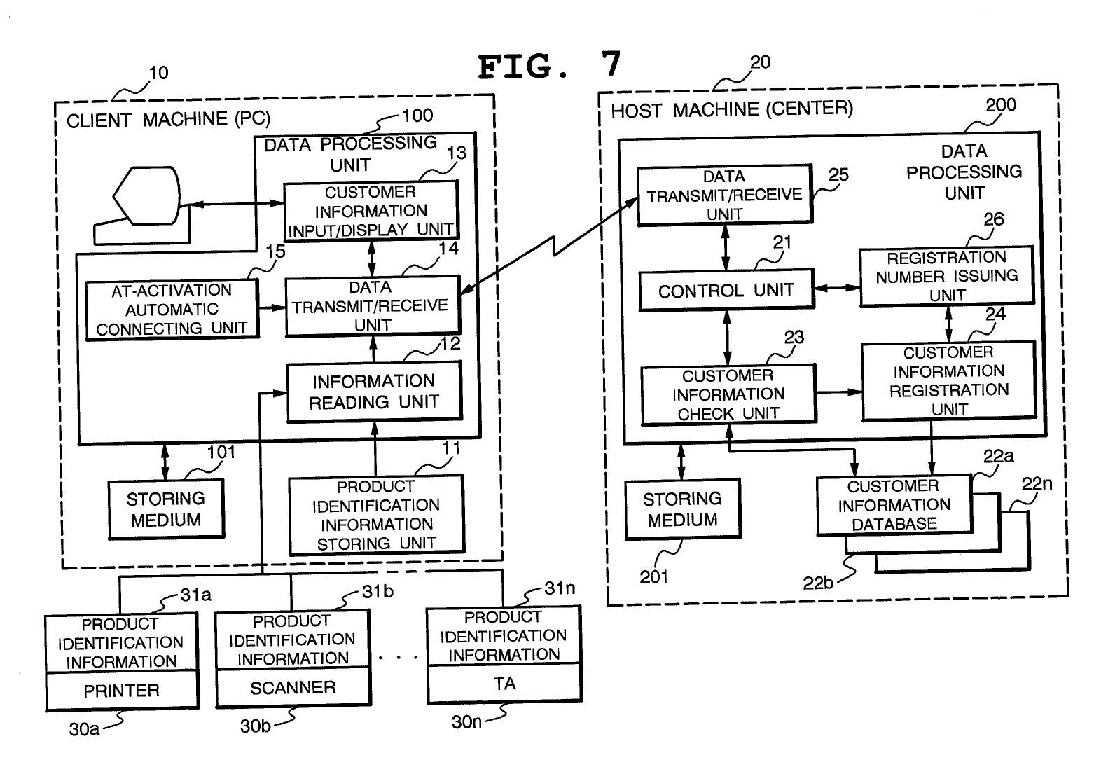

Next, a customer information control system according to a second embodiment of the present invention will be described. FIG. 7 is a block diagram showing the whole structure of the customer information control system according the second embodiment. In FIG. 7, the same reference numerals are attached to the same components as those of FIG. 1, and their description is omitted there.

In the second embodiment, a client machine 10 comprises an at-activation automatic connecting unit 15 for automatically connecting with a host machine 20 on recognizing only the first activation after its purchase. Further, a printer 30a, a scanner 30b, . . . , a TA (terminal adapter) 30n are connected to the client machine 10 as illustrated. The peripheral equipment to be connected to the client machine 10 is not restricted to the illustrated ones.

The printer 30a, the scanner 30b, . . . , a TA (terminal adapter) 30n are respectively provided with the storing units 31a, 31b, . . . , 31n for storing the product identification information including the serial number for uniquely identifying each equipment, which can be read by an information reading unit 12 of the client machine 10.

The host machine 20 is provided with a registration number issuing unit 26 for issuing the user registration number RN to be attached to every customer that has been registered newly. It is also provided with a plurality of customer information databases 22a, 22b, . . . , 22n for every registered machine.

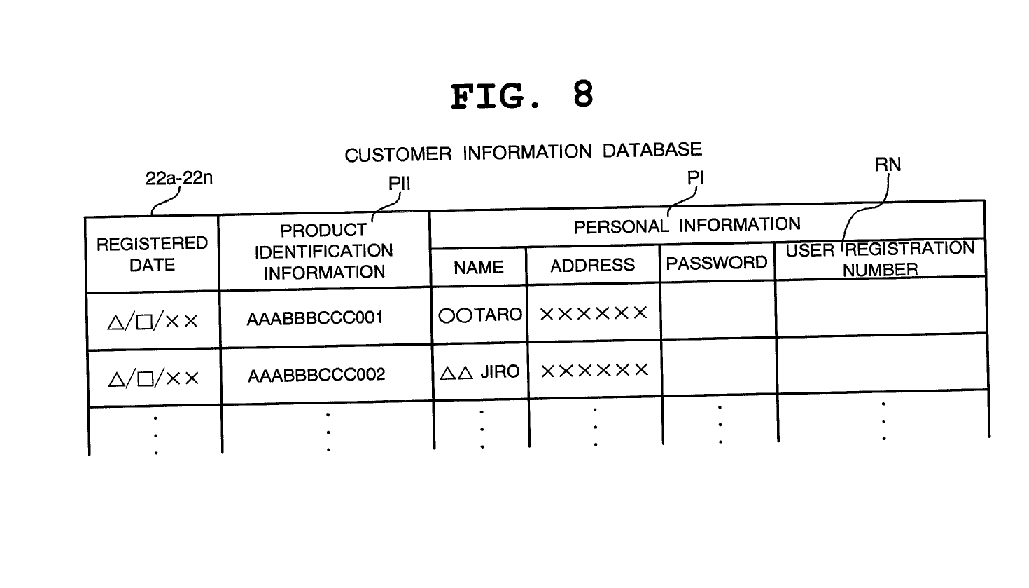

The structure of the respective customer information databases 22a, 22b, . . . , 22n is shown in FIG. 8. The user registration number RN is added here.

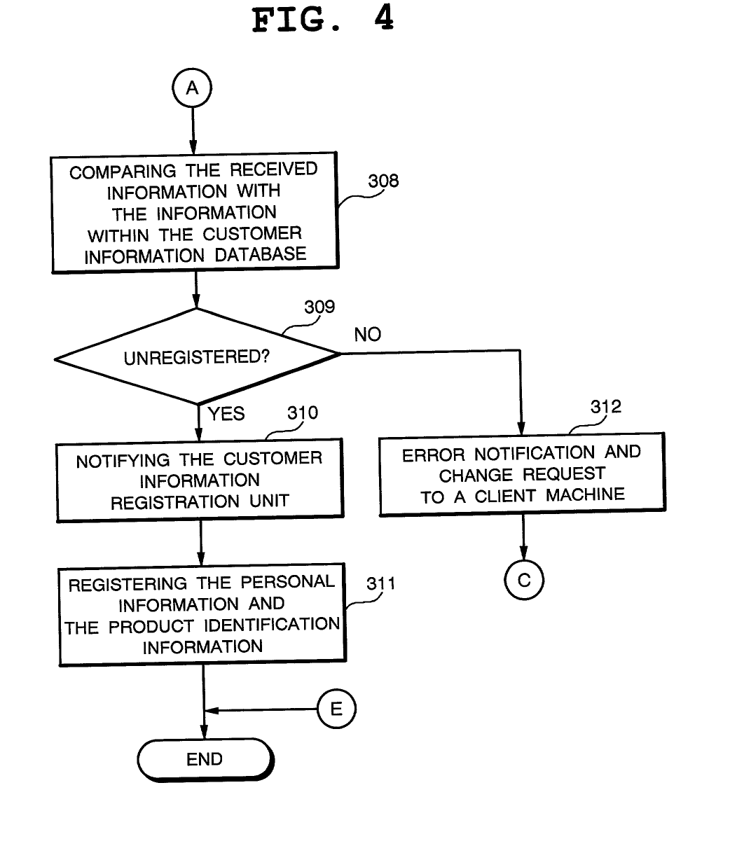

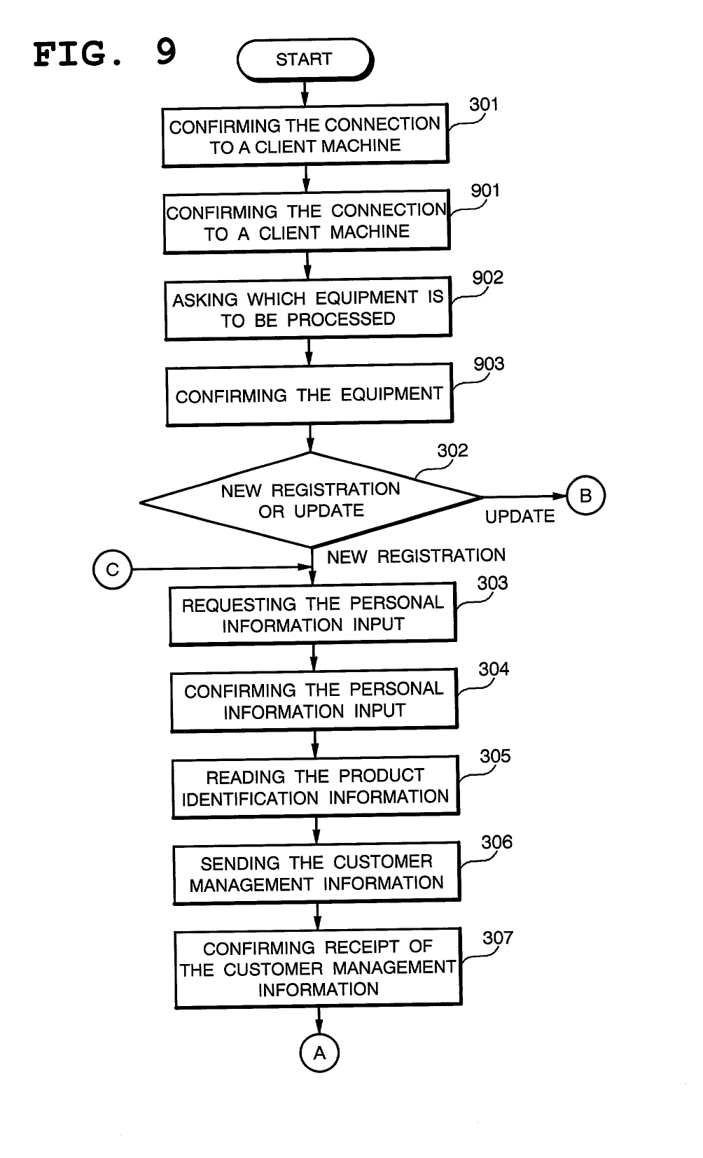

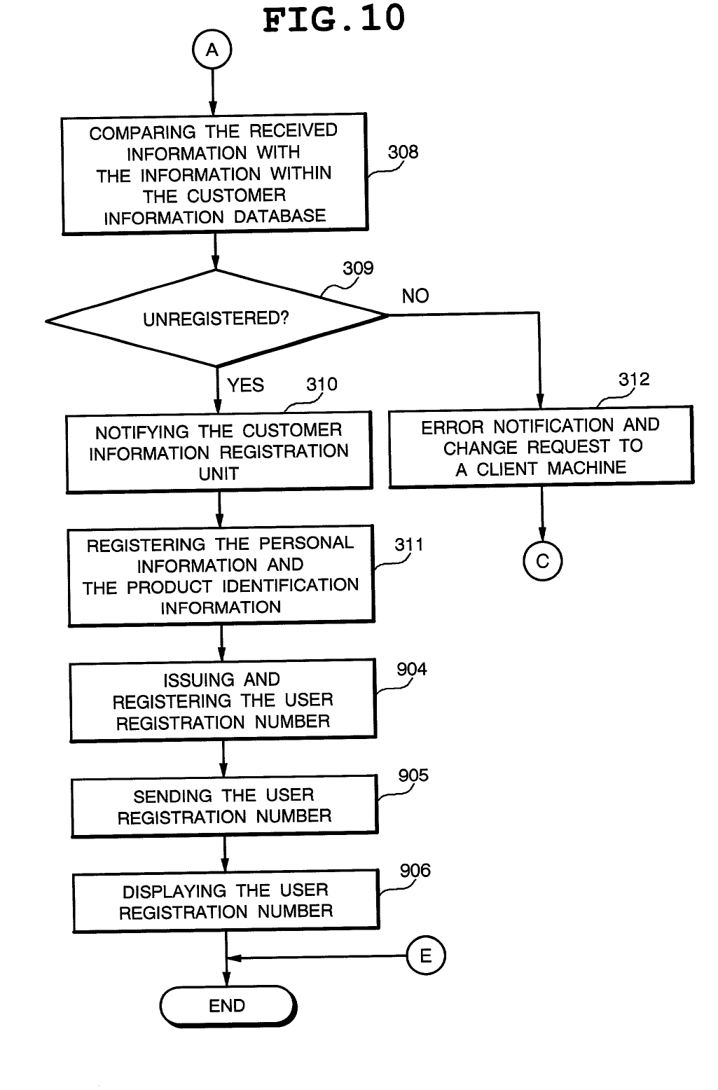

The operation of the customer information control system according to the second embodiment having the above structure will be described with reference to the flow charts of FIGS. 9 and 10. In the flow charts of FIGS. 9 and 10, the same reference numerals in the flow charts of FIGS. 3 and 4 are attached to the steps having the identical processing. Here, only the steps newly added to FIGS. 3 and 4 will be described.

Only at the first activation after purchase of the client machine 10, the at-activation automatic connecting unit 15 automatically connects the client machine 10 with the host machine 20. Thereafter, it is by a customer's connecting operation that the client machine 10 is connected with the host machine 20.

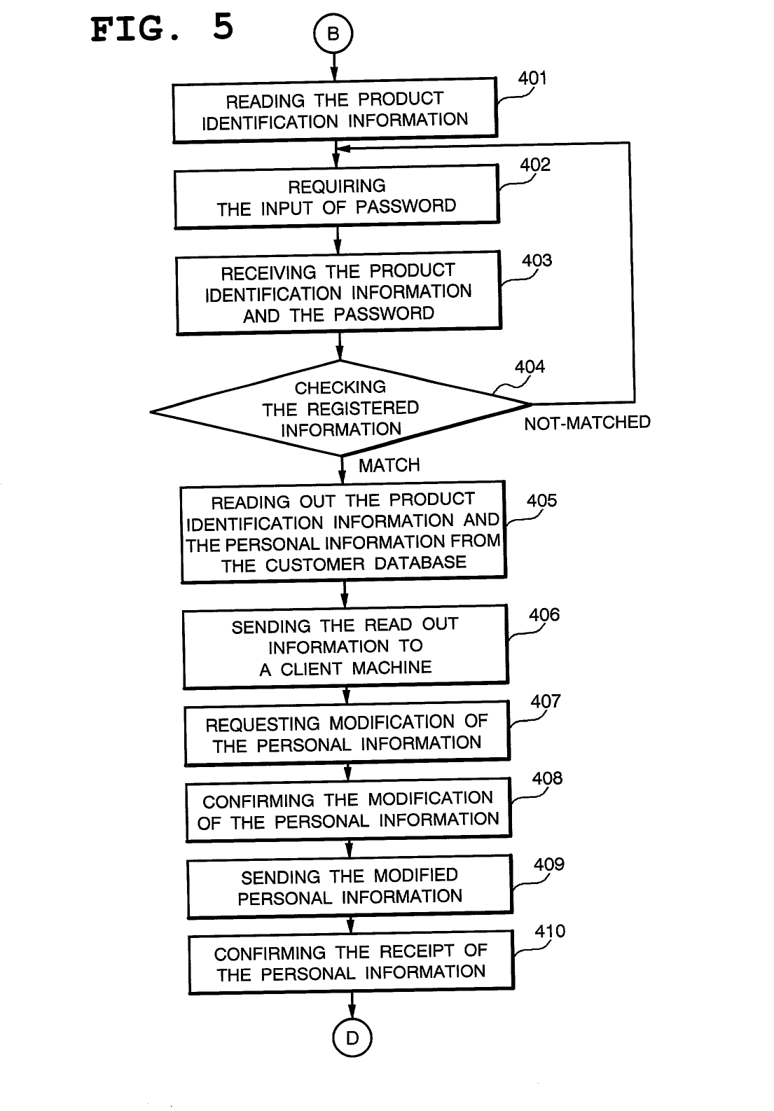

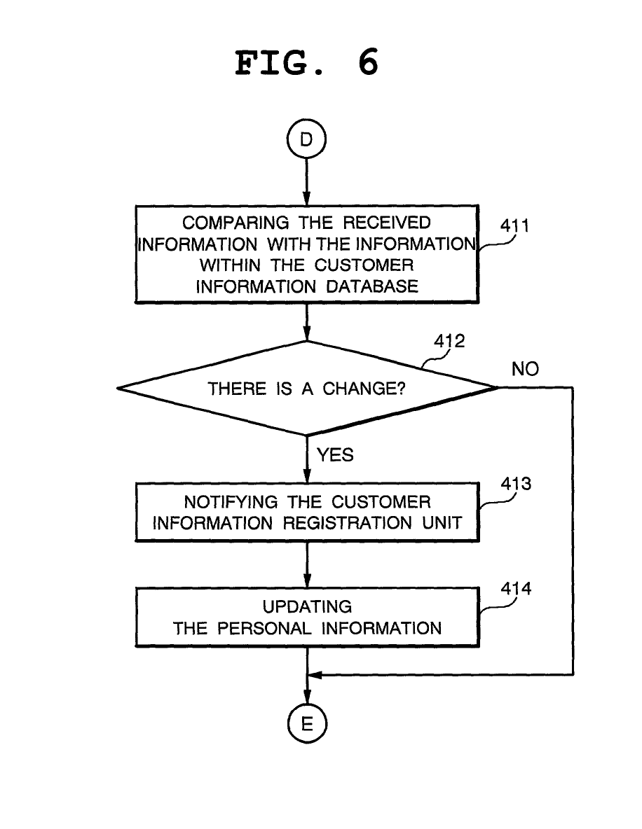

After confirming the connection to the client machine 10, the control unit 21 of the host machine 20 recognizes the client machine 10 itself and the peripheral equipment (printer 30a, scanner 30b, . . . , TA 30n) connected to it (Step 901). It asks which equipment is to be registered newly in the customer management information or to be updated (Step 902). After confirming the equipment (Step 903), the processing from Step 302 to Step 312 shown in FIGS. 3 and 4 and the processing from Step 401 to Step 414 shown in FIGS. 5 and 6 will be executed as the registration and update processing as for the equipment.

In the second embodiment, after registering the personal information and the product identification information in the customer information database; 22a, 22b, . . . , 22n corresponding to the equipment selected in Step 311, the user registration number RN for the customer is automatically issued by the registration number issuing unit 26 and the user registration number RN is stored in the customer information database; 22a, 22b, . . . , 22n (Step 904).

The user registration number RN is sent to the client machine 10 (Step 905), which is displayed on the customer information input/display unit 13 to be notified to the customer (Step 906).

According to the above-mentioned operation, the second embodiment can prevent a registration mistake and double registration owing to a user's mistake, as well as prevent such a false registration that the product identification information is maliciously changed, and it can save a lot of customer's labor toward customer registration and a lot of operator's labor of information input. Further, the second embodiment, while recognizing the peripheral equipment connected to a client machine 10, can register the product identification information and the personal information selectively and issue the user registration number automatically, thereby reducing more the customer's and operator's labor in a customer information control and simplifying the customer information control further.

The above-mentioned customer information control system can be realized, needless to say, by the hardware. Also by the software, it can be realized, specifically by a customer information control program for realizing the above-mentioned functions, which is written in each storing medium 101, 201 such as a magnetic disk, a semiconductor memory, or the like of the client machine 10 and the host machine 20. The customer information control program is read out by each data processing unit (CPU) 100, 200 of the client machine 10 and the host machine 20 from each storing medium 101, 201, so to control the operation of each data processing unit 100, 200, thereby realizing the function of each unit as mentioned above in the customer management processing. Namely, the processing shown in FIGS. 3 to 6 and the processing shown in FIGS. 9 and 10 will be carried out.

As set forth hereinabove, according to the customer information control system and customer information control method of the present invention and according to the storing medium which stores the customer information control program of the present invention, the product identification information can be obtained automatically, not by handwork, thereby preventing a registration mistake and double registration owing to a user's mistake, and further preventing such a false registration that the product identification information is maliciously changed.

Further, in the present invention, the customer's labor of filling his or her personal information and the input work of the customer management information into a database can be saved, thereby reducing a lot of customer's trouble toward customer registration and a lot of operator's trouble of information input and simplifying the customer information control.

Further, while recognizing the peripheral equipment connected to a client machine, the present invention can register the product identification information and the personal information selectively and issue the user registration number automatically, thereby saving a lot of customer's trouble and a lot of operator's trouble in the customer information control and simplifying the customer information control further.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A customer information control system of electronic equipment for controlling personal information and product identification information of the electronic equipment belonging to a customer, as customer management information, on a host machine, wherein
said electronic equipment comprising:
a product identification information storing unit for storing said product identification information in a readable way;
an information reading unit for automatically reading out said product identification information from said product identification information storing unit;
an input unit for entering said personal information; and
a data sending unit for sending said product identification information and said personal information to said host machine as said customer management information;
said host machine comprising:
a receiving unit for receiving said customer management information from said electronic equipment;
a customer information database for storing said customer management information; and
a registering unit for registering the sent customer management information into said customer information database when said customer management information sent from said electronic equipment has not been registered in said customer information database.

2. A customer information control system of electronic equipment as set forth in claim 1, wherein
said electronic equipment further comprising
a display unit for displaying said personal information and a request and result from said host machine, and
a data receiving unit for receiving the request and result from said host machine,
said host machine comprising
a checking unit for comparing said customer management information sent from said electronic equipment with said customer management information within said customer information database.

3. A customer information control system of electronic equipment as set forth in claim 1, wherein
said host machine further comprising
a control unit for requiring said electronic equipment to enter said personal information after confirming the connection to the electronic equipment and controlling said information reading unit to read out said product identification information from said product identification information storing unit after confirming entry of said personal information.

4. A customer information control system of electronic equipment as set forth in claim 1, wherein
said host machine comprises a control unit for,
after confirming the connection to the electronic equipment, asking the electronic equipment whether said customer management information is to be registered newly or to be updated;
when the same information is to be registered newly, controlling said information reading unit to read out said product identification information from said product identification information storing unit, after confirming the entry of said personal information from said electronic equipment,
when the same information is to be updated, controlling said checking unit to compare said personal information entered from said electronic equipment and said product identification information read out by said information reading unit with said customer management information within said customer information database, and when there is a match, controlling said registering unit to update said customer management information within said customer information database according to said personal information changed by said electronic equipment.

5. A customer information control system of electronic equipment as set forth in claim 1, wherein
when said customer management information sent from said electronic equipment has not been registered, said checking unit of said host machine notifies the effect to said registering unit, so to register the sent customer management information into said customer information database, while when the sent customer management information has been already registered, said checking unit notifies the error to said input unit and displaying unit of said electronic equipment and makes a change request.

6. A customer information control system of electronic equipment as set forth in claim 1, wherein
said electronic equipment comprising
a control unit for requiring said electronic equipment to enter said personal information after confirming the connection to said electronic equipment and controlling said information reading unit to read out said product identification information from said product identification information storing unit after confirming the entry of said personal information.

7. A customer information control system of electronic equipment as set forth in claim 1, wherein
said electronic equipment comprises a control unit for,
after confirming the connection to said host machine, asking said host machine whether said customer management information is to be registered newly or to be updated;
when the same information is to be registered newly, controlling said information reading unit to read out said product identification information from said product identification information storing unit, after confirming the entry of said personal information, while
when the same information is to be updated, controlling said checking unit to compare the entered personal information and said product identification information read out by said information reading unit with said customer management information within said customer information database, and when there is a match, controlling said registering unit to update said customer management information within said customer information database according to the changed personal information.

8. A customer information control system of electronic equipment as set forth in claim 1, wherein
said host machine comprising
a registration number issuing unit for issuing a user registration number of uniquely identifying a customer indicated in the registered product identification information and personal information,
said registering unit registering the issued user registration number into said customer information database, and sending the same registration number to said electronic equipment.

9. A customer information control system of electronic equipment as set forth in claim 1, wherein
said electronic equipment belonging to a customer consists of a computer and peripheral equipment connected to said computer,
said computer and peripheral equipment respectively comprising said product identification information storing unit for storing said product identification information for uniquely identifying said computer and peripheral equipment,
said host machine comprising
said plurality of customer information databases for every computer and peripheral equipment.

10. A customer information control system as set forth in claim 1, wherein
said electronic equipment comprises an automatic connecting unit for automatically connecting with said host machine upon recognizing the fist activation.

11. A customer information control method of electronic equipment for controlling personal information and product identification information of said electronic equipment belonging to a customer, as customer management information, on a host machine, comprising the following steps of:
automatically reading out said product identification information from said product identification information storing unit for storing said product identification information of said electronic equipment in a readable way;
sending said product identification information and said personal information entered from said electronic equipment to said host machine as said customer management information;
comparing said customer management information sent from said electronic equipment with said customer management information registered in said customer information database of said host machine; and
registering the sent customer management information into said customer information database when the sent customer management information has not been registered in said customer information database as the result of the comparison.

12. A customer information control method of electronic equipment as set forth in claim 11, further comprising
a step of requiring said electronic equipment to enter said personal information after confirming the connection to said electronic equipment and reading out said product identification information from said product identification information storing unit after confirming the entry of said personal information.

13. A customer information control method of electronic equipment as set forth in claim 11, comprising the following steps of:
after confirming the connection to said electronic equipment, asking said electronic equipment whether said customer management information is to be registered newly or to be updated;
when the same information is to be registered newly, reading out said product identification information from said product identification information storing unit, after confirming the entry of said personal information from said electronic equipment; and
when the same information is to be updated, comparing said personal information entered from said electronic equipment and said product identification information read out from said customer information database with said customer management information within said customer information database, and when there is a match, updating said customer management information within said customer information database according to said personal information changed on the side of said electronic equipment.

14. A customer information control method of electronic equipment as set forth in claim 11, comprising
a step of, when said customer management information sent from said electronic equipment has not been registered, registering the sent customer management information into said customer information database, and when the sent customer management information has been already registered, notifying the error and making a change request to said electronic equipment.

15. A customer information control method of electronic equipment as set forth in claim 11, comprising the following steps of:
issuing a user registration number of uniquely identifying a customer indicated in the registered product identification information and personal information, from said host machine; and
registering the issued user registration number into said customer information database as well as sending the same registration number to said electronic equipment.

16. A customer information control method of electronic equipment as set forth in claim 11, wherein
said electronic equipment consists of a computer and peripheral equipment connected to said computer, said computer and peripheral equipment respectively comprising said product identification information storing unit for storing said product identification information for uniquely identifying said computer and peripheral equipment.

17. A computer readable memory for storing a customer information control program for controlling personal information and product identification information of electronic equipment belonging to a customer, as customer management information, on a host machine, wherein
said customer information control program automatically reads out said product identification information from said product identification information storing unit for storing said product identification information of said electronic equipment in a readable way,
sends said product identification information and said personal information entered from said electronic equipment to said host machine as said customer management information,
compares said customer management information sent from said electronic equipment with said customer management information registered in said customer information database of said host machine, and
registers the sent customer management information into said customer information database when the sent customer management information has not been registered in said customer information database as the result of the comparison.

18. A computer readable memory for storing a customer information control program as set forth in claim 17, wherein
said customer information control program
requires said electronic equipment to enter said personal information after confirming the connection to said electronic equipment and reads out said product identification information from said product identification information storing unit after confirming the entry of said personal information.

19. A computer readable memory for storing a customer information control program as set forth in claim 17, wherein
said customer information control program,
after confirming the connection to said electronic equipment, asks said electronic equipment whether said customer management information is to be registered newly or to be updated;
when the same information is to be registered newly, reads out said product identification information from said product identification information storing unit, after confirming the entry of said personal information from said electronic equipment, and
when the same information is to be updated, compares said personal information entered from said electronic equipment and said product identification information read out from said customer information database with said customer management information within said customer information database, and when there is a match, updates said customer management information within said customer information database according to said personal information changed on the side of said electronic equipment.

20. A computer readable memory for storing a customer information control program as set forth in claim 17, wherein
said customer information control program,
when said customer management information sent from said electronic equipment has not been registered, registers the sent customer management information into said customer information database, and when the sent customer management information has been already registered, notifies the error and makes a change request to said electronic equipment.

21. A computer readable memory for storing a customer information control program as set forth in claim 17, wherein
said customer information control program
issues a user registration number of uniquely identifying a customer indicated in the registered product identification information and personal information, from said host machine, and
registers the issued user registration number into said customer information database as well as sends the same registration number to said electronic equipment.

22. A computer readable memory for storing a customer information control program as set forth in claim 17, wherein
said electronic equipment consists of a computer and peripheral equipment connected to said computer, said computer and peripheral equipment respectively comprising said product identification information storing unit for storing said product identification information for uniquely identifying said computer and peripheral equipment.
